(19) United States
(12) Patent Application Publication
(10) Pub. No.: US 2007/0088944 A1
(43) Pub. Date: Apr. 19, 2007

(54) Data processing apparatus

(75) Inventors: Yasuhiro Nakai, Kyoto (JP); Masao Saeda, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/581,844

(22) Filed: Oct. 16, 2006

(30) Foreign Application Priority Data
Oct. 18, 2005 (JP) 2005-302614

(51) Int. Cl. G06F 1/24

(52) U.S. Cl. 713/100

(57) ABSTRACT

The data processing apparatus includes a timer that measures a time, an apparatus control portion that controls switching to one of the at least two different processing modes depending on the time, and an HD for storing data. When during the time zone where one processing mode is being executed the data to be processed in the other processing mode is entered, the apparatus control portion temporarily holds the entered data on the HD, and reads for print processing the data held on the HD after the time to execute the other processing mode.

This Nonprovisional application claims priority under 35 U.S.C. §119 (a) on Patent Application No. 2005-302614 filed in JAPAN on Oct. 18, 2005, the entire contents of which are hereby incorporated herein by references.

### FIELD OF THE INVENTION

The present invention relates generally to a data processing apparatus, and, more particularly, to a data processing apparatus having a function to switch its processing modes depending on time (time zone).

### BACKGROUND OF THE INVENTION

Data processing apparatuses such as digital multi-function peripherals (MFP) have hitherto been disposed in shops, etc., to provide printing service or other various services to common customers. In case of using the data processing apparatuses for business use, their processing modes are properly switched for use between a printing service processing mode and a business-use processing mode.

In case of disposing the data processing apparatuses for use in shops, etc., it may be conceivable that their forms of use are changed depending on the time zone in such a manner that they are used as self-copiers for common customers in the daytime, while being used for business use in the nighttime after closing the shops. In such a case, the processing modes need to be switched depending on the time zone to facilitate use of users. In the above example, the operations require a lot of time and effort since the person in charge of system has to change the setting each time such that the printing service processing mode is set in the daytime while the business-use processing mode is set in the nighttime.

Data processing apparatuses are known that have functions to switch their modes depending on the time (see, e.g., Japanese Laid-Open Patent Publication Nos. 2001-331158 and 2005-71269). Japanese Laid-Open Patent Publication No. 2001-331158 discloses electric equipment such as a copier arranged to display switchably an operation mode to provide a display in the form of a user interface when operating a predetermined drive system and a distribution information display mode to display distribution information distributed through a predetermined communication path so that the distribution information is displayed during the time zone not in the operation mode.

Japanese Laid-Open Patent Publication No. 2005-71269 discloses an image forming apparatus arranged to switch, in accordance with a timer, an ordinary mode to supply a predetermined energy for an object to be controlled and an energy saving mode to suppress the energy consumption of the object to be controlled.

Although Japanese Laid-Open Patent Publication No. 2001-331158 describes a configuration to switch to the operation mode when the user performs a predetermined operation and then compulsorily switch to the distribution information display mode after the elapse of a predetermined time after the operation, this is not intended to switch the modes for each predetermined time zone and further to switch the printing service processing mode provided for the common consumers and the business-use processing mode depending on the time zones.

Although Japanese Laid-Open Patent Publication No. 2005-71269 describes a configuration to provide switching between the ordinary mode and the energy saving mode by use of the timer, this is not intended to switch the printing service processing mode provided for the common consumers and the business-use processing mode depending on the time zones.

Assuming in the conventional data processing apparatuses that the processing modes are switched depending on the time zones such that the printing service processing mode is set during the time zone of daytime and that the business-use processing mode is set during the time zone of nighttime, it is ordinarily infeasible to input data to be processed in the business-use processing mode during the execution of the printing service processing mode. Accordingly, in case of outputting data created by a business-use PC (Personal Computer), etc., during the time zone where the printing service processing mode is being executed, the data outputting process needs to be performed in sequence after the elapse of time to switch to the business-use processing mode, resulting in poor business efficiencies.

### SUMMARY OF THE INVENTION

It is therefore an object of the present invention to enable a data processing apparatus having at least two different processing modes to switch the processing modes depending on the time (time zone) and to process, when during the time zone for execution of one processing mode data to be processed in other processing mode is entered, the entered data after the arrival at the hour to execute the other processing mode.

Another object of the present invention is to provide a data processing apparatus having at least two different processing modes, comprising a timer that measures a time; and a control portion that controls switching to one of the at least two different processing modes depending on the time, the control portion providing a control such that when during a time zone where one of the processing modes is being executed data to be processed in the other processing mode is entered, the entered data is processed after a time to execute the other processing mode.

Another object of the present invention is to provide a data processing apparatus further comprising a storage portion that holds the entered data, wherein the data held on the storage portion is read and processed the instant the time to execute the other processing mode arrives.

Another object of the present invention is to provide a data processing apparatus further comprising a storage portion that holds the entered data, wherein a list of the data held on the storage portion is allowed to be displayed the instant the time to execute the other processing mode arrives so that data selected by a user from the list is read from the storage portion for processing.

Another object of the present invention is to provide a data processing apparatus, wherein the apparatus notifies that data is held on the storage portion the instant the time to execute the other processing mode arrives.

Another object of the present invention is to provide a data processing apparatus further comprising a first input portion that reads a document to enter data, and a second input portion that enters data from an external device via a network, wherein the control portion determines based on a user's option whether when during the time zone where the one processing mode is being executed data is entered from the second input portion, the entered data is to be processed after the time to execute the other processing mode.

Another object of the present invention is to provide a data processing apparatus further comprising a storage portion that holds the entered data, wherein a list of the data held on the storage portion is allowed to be displayed during the time zone where the one processing mode is being executed so that data selected by the user from the list is read from the storage portion for processing.

Another object of the present invention is to provide a data processing apparatus, wherein the one processing mode is a printing service mode for providing printing services to charge for the services, wherein the one processing mode is a printing service mode for providing printing services to charge for the services, wherein the other processing mode is a business-use mode for use in general business, and wherein data to be processed in the other processing mode is data entered from a predetermined business-use terminal used in the business-use mode via a network.

### BRIEF DESCRIPTION OF THE DRAWINGS

FIG. 1 is a block diagram of a schematic configuration example of a data processing apparatus according to an embodiment of the present invention.

FIG. 2 depicts a configuration example of a system including a digital multi-function peripheral and an accounting device that are connected to each other.

FIG. 3 depicts a configuration example of an operation portion included in the digital multi-function peripheral.

FIG. 4 depicts an example of a user setting screen displayed on a touch panel of the digital multi-function peripheral.

FIG. 5 depicts an example of an authentication information input screen for allowing a key operator program setting screen to appear on the touch panel of the digital multi-function peripheral.

FIG. 6 depicts another example of the authentication information input screen.

FIG. 7 depicts an example of a key operator program screen appearing on the touch panel of the digital multi-function peripheral.

FIG. 8 depicts an example of a time management screen appearing on the touch panel of the digital multi-function peripheral.

FIG. 9 depicts an example of a schedule setting screen appearing on the touch panel of the digital multi-function peripheral.

FIG. 10A depicts an example of a time setting screen appearing on the touch panel of the digital multi-function peripheral.

FIG. 10B depicts an example of a program setting screen appearing on the touch panel of the digital multi-function peripheral.

FIGS. 11A and 11B depict examples of an operation screen appearing on the touch panel of the digital multi-function peripheral.

FIG. 12 is a flow diagram for explaining the flow of operation screen switching display processing effected by the digital multi-function peripheral of the present invention.

FIG. 13 is a flow diagram for explaining the flow of processing on data reception effected by the digital multi-function peripheral of the present invention.

FIG. 14 is a flow diagram for explaining the flow of processing when printing out hold data during the printing service effected by the digital multi-function peripheral of the present invention.

### PREFERRED EMBODIMENTS OF THE INVENTION

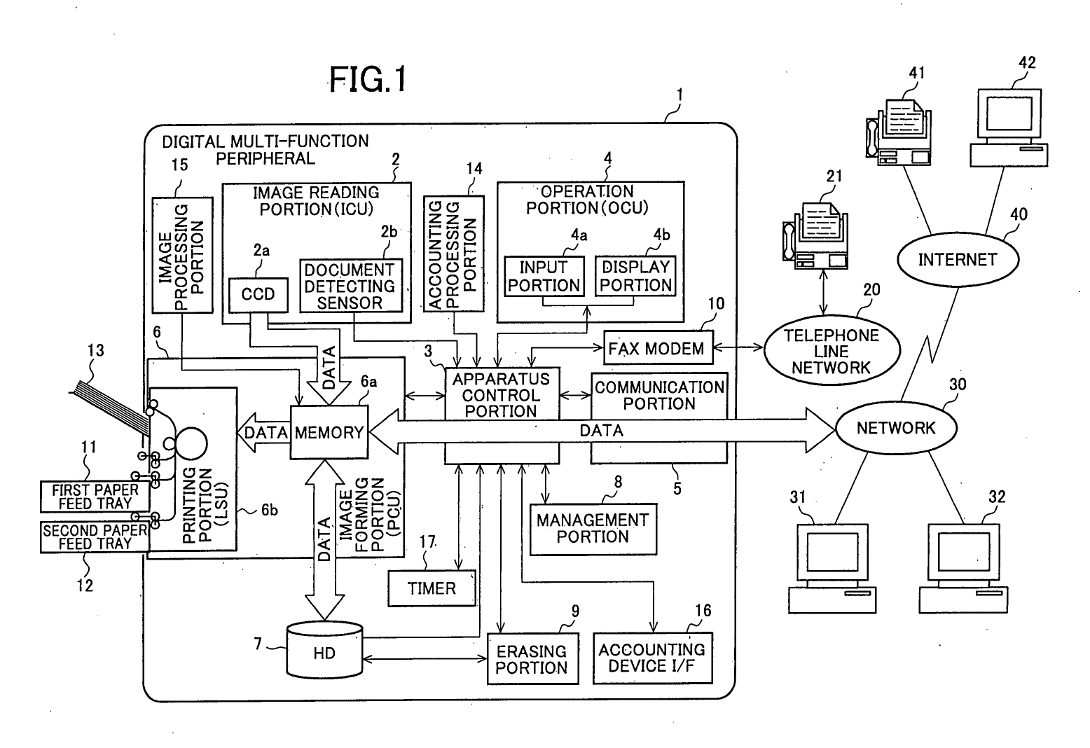

FIG. 1 is a block diagram of a schematic configuration example of a data processing apparatus according to an embodiment of the present invention. Referring to FIG. 1, reference numeral 1 denotes a data processing apparatus, 20 denotes a telephone line network, 30 denotes a communication network in the form of a LAN, etc., 21 denotes a facsimile device connected to the telephone line network 20, reference numerals 31 and 32 denote terminal devices such as personal computers (PCs) connected to the communication network 30, reference numeral 40 denotes an internet serving as a wide-area communication network, 41 denotes a facsimile device connected to the internet 40, and reference numeral 42 denotes a terminal device such as a PC connected to the internet 40. The data processing apparatus 1 enables transmission/reception of image data or document data by FAX between the facsimile devices 21 and 41, and enables transmission/reception of image data or document data using electronic mails, etc., between the terminal devices 31, 32, and 42.

The data processing apparatus 1 of this embodiment will hereinafter be described as a digital multi-function peripheral 1 that is a representative example of the data processing apparatus 1 having any two or more functions of scanner function, copier function, facsimile function, and printer function.

Referring to FIG. 1, the digital multi-function peripheral 1 includes an image control unit (ICU) 2 acting as an image reading portion that reads a document to enter image data, an apparatus control portion 3 that controls functions of the digital multi-function peripheral 1, an operation control unit (OCU) 4 acting as an operation portion that accepts a user input, a communication portion 5 that communicates with the terminal devices 31 and 32 via the communication network 30 such as a LAN and that communicates with the facsimile device 41 and the terminal device 42 via the internet 40, a process control unit (PCU) 6 acting as an image forming portion that performs image data print processing, a hard disk (HD) 7 for storing image data, etc., a management portion 8 that is a memory storing control information and setting information on the digital multi-function peripheral 1, an erasing portion 9 that erases image data stored in the HD 7, and a FAX modem 10 for communicating with the facsimile device 21 via the telephone line network 20.

The digital multi-function peripheral 1 includes a first paper feed tray 11, a second paper feed tray 12, and a paper discharge tray 13. The first 11 and the second 12 paper feed trays are fitted removably to the digital multi-function peripheral 1 to feed paper for image formation to the image forming portion 6. The paper discharge tray 13 receives paper fed from the first 11 or the second 12 paper feed tray and having images formed thereon by the image forming portion 6.

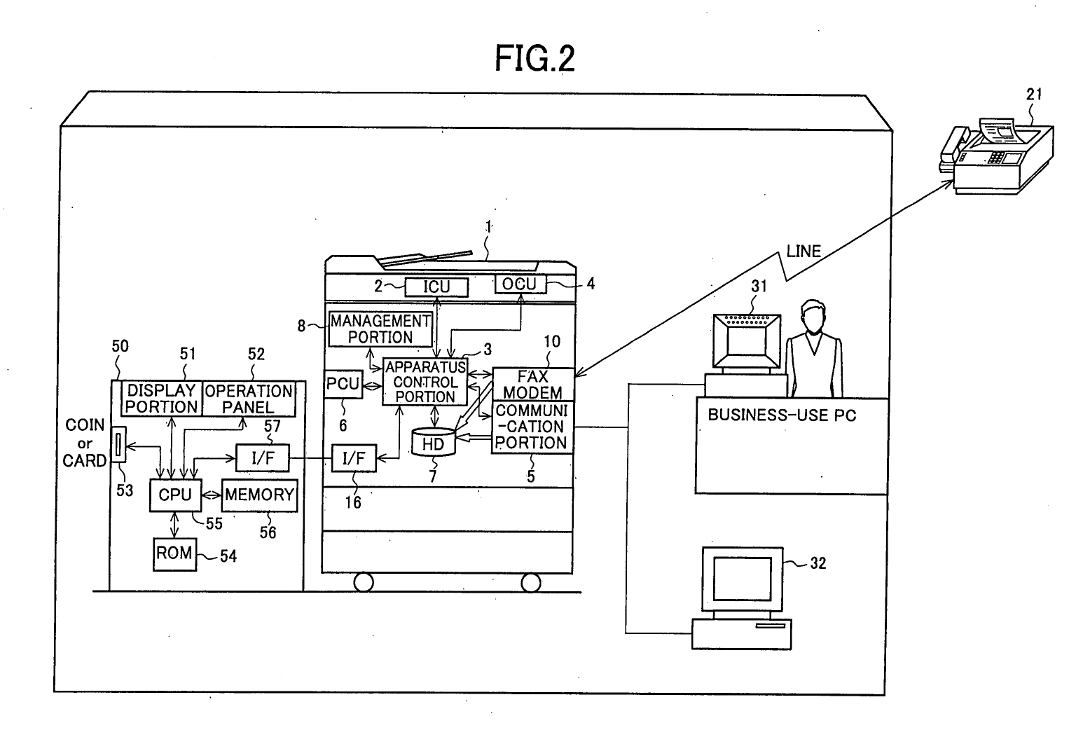

The digital multi-function peripheral 1 further includes an accounting processing portion 14, an image processing portion 15, an accounting device interface (accounting device I/F) 16, and a timer 17. The accounting device I/F 16 is an interface that connects to an accounting device (shown in FIG. 2 described later) for charging for printing services provided by the digital multi-function peripheral 1.

The accounting processing portion 14 is connected to the apparatus control portion 3 and performs e.g., setting of charge for the above accounting processing. The apparatus control portion 3 controls the accounting device to charge by the number of copies when e.g., 10 yen per copy is set by the accounting processing portion 14. The accounting device can be of a coin type or a card (prepaid card, etc.) type. The image processing portion 15 subjects image data entered in the image forming portion 6 to various image processings. The timer 17 is connected to the apparatus control portion 3 and is a clock that measures time (including the date and time, etc).

Detailed description will now be made of the units of the digital multi-function peripheral 1 shown in FIG. 1.

The digital multi-function peripheral 1 has the apparatus control portion 3 that includes a CPU performing calculations and a RAM storing temporary information attendant on the calculations. The apparatus control portion 3 includes a ROM storing a control program for control of the digital multi-function peripheral 1. The apparatus control portion 3 connects to the management portion 8 in the form of a memory storing management information (various pieces of control information) for management of processings effected by the digital multi-function peripheral 1.

The apparatus control portion 3 connects to the image reading portion 2 that reads images recorded on a document to create image data. The image reading portion 2 includes a CCD (Charge Coupled Device) 2a for capturing document images as image data, and a document detecting sensor 2b that detects whether a document is present on a document table, an automatic document feeder (ADF), etc.

The apparatus control portion 3 connects to the image forming portion 6 that forms image data on recording paper. The image forming portion 6 includes a memory 6a temporarily storing image data, a laser scanning unit (LSU) 6b acting as a printing portion that forms images from image data stored in the memory 6a and that records the thus formed images on recording paper, the first 11 and the second 12 paper feed trays that are trays for feeding paper for forming images thereon by the printing portion 6b, and the paper discharge tray 13 that is a tray for ejecting paper.

The apparatus control portion 3 connects to the FAX modem 10 for facsimile communication, which in turn is connected to the telephone line network 20. By facsimile communication, the digital multi-function peripheral 1 is capable of transmitting image data created by the image reading portion 2, via the telephone line network 20 connected to the FAX modem 10, to the other facsimile device 21. The digital multi-function peripheral 1 is capable of receiving image data transmitted via the telephone line network 20 from the other facsimile device 21 by the FAX modem 10, to form images from the thus received image data by the image forming portion 6.

The apparatus control portion 3 connects to the communication portion 5 for allowing the digital multi-function peripheral 1 to transmit/receive information to/from the exterior. The communication portion 5 is connectable to the communication network 30 such as an in-house LAN, to which is connectable the terminal devices 31 and 32 such as one or more personal computers (PCs). In the ordinary state where the digital multi-function peripheral 1 operates singly, the communication portion 5 is connected to the communication network 30 so as to interchange information with the terminal devices 31 and 32 via the communication network 30.

The digital multi-function peripheral 1 is capable of transmitting image data created by the image reading portion 2 from the communication portion 5 to the terminal devices 31 and 32. The digital multi-function peripheral 1 is capable of receiving image data transmitted from the terminal devices 31 and 32 by the communication portion 5 and of forming images from the received image data by the image forming portion 6.

The communication network 30 is connected further to the internet 40 that is a wide-area communication network. By using e.g., a manner of transmitting electronic mail having image data attached thereto, the communication portion 5 is capable of receiving image data via the communication network 30 and the internet 40 from the facsimile device 41 and the external terminal device 42 that are connected to the internet 40.

The apparatus control portion 3 connects to the operation portion 4 that accepts an operation from a user. The operation portion 4 includes an input portion 4a in the form of a touch panel, a numeric keypad, etc., to which information such as a control instruction is entered by the user's operation, and a display portion 4b in the form of a liquid crystal panel that displays information necessary for the operation. An authentication code is entered into the operation portion 4 for authenticating the user or the operator of the data processing apparatus. The authentication code may be entered from an external device via the FAX modem 10 or the communication portion 5.

The apparatus control portion 3 connects to the hard disk (HD) 7. The HD 7 stores image data relating to image processing for image data, etc., created by the image reading portion 2. The apparatus control portion 3 connects to the erasing portion 9. The erasing portion 9 erases data stored and held on the HD 7 in accordance with control provided by the apparatus control portion 3.

Brief description will hereinafter be made of operation examples relating to image processing modes provided by the digital multi-function peripheral 1.

(Copy Mode)

In case of using the digital multi-function peripheral 1 according to the embodiment as a copier, image data of a document read by the image reading portion 2 is outputted as a copy from the image forming portion 6.

The image reading portion 2 is provided with the CCD 2a so that an image of a document disposed at a reading position can electronically be read. The read image data of the document is then completed as output data on the memory 6a, and temporarily stored on the HD 7. When a plurality of documents are present, these operations of reading and storing are repeated. Afterward, based on a processing mode specified from the operation portion 4, the image data stored on the HD 7 is successively read at proper timing to be sent to the memory 6a. In unison with the timing of writing into the printing portion 6b, the image data is transferred from the memory 6a to the printing portion 6b.

Also in case of printing a plurality of copies from the read image data, the image data is stored similarly as output data on the HD 7 on a page-to-page basis, and is sent from the HD 7 to the memory 6a in conformity with the outputting mode. These operations are repeated by the number of outputted copies, after which the image data is transferred to the printing portion 6b in unison with the timing of writing into the printing portion 6b.

(Printer Mode)

In case of using the digital multi-function peripheral 1 according to the embodiment as a printer, image data received from the communication portion 5 is outputted via the memory 6a, etc., from the image forming portion 6.

The communication portion 5 is connected to the communication network 30 by utilizing cable or radio and receives image data from the terminal devices 31 and 32 that are external devices connected on the communication network 30. The thus received image data is sent as output image data on a page-to-page basis to the memory 6a and is temporarily stored on the HD 7. The image data is again sent from the HD 7 to the memory 6a to be transferred to the printing portion 6b in the same manner as the case of using as the copier.

(Scanner Mode)

In case of using the digital multi-function peripheral 1 according to the embodiment as a network scanner, image data of a document read by the image reading portion 2 can be transmitted from the communication portion 5 via the communication network 30 to the terminal devices 31 and 32. In this case as well, the document is electronically read by the CCD 2a of the image reading portion 2. The thus read document image data is then completed as output data on the memory 6a and is temporarily stored on the HD 7. The image data is again sent from the HD 7 to the memory 6a and, after establishing a communication with a sending destination specified via the operation portion 4, is transmitted from the communication portion 5 to the sending destination.

(Facsimile Mode)

The communication portion 5 is further connected to the facsimile device 41 by way of the communication network 30 and the internet 40. The FAX modem 10 may connect to the facsimile device 21 by way of the telephone line network 20. Similar operations are performed also in case of using the digital multi-function peripheral 1 according to the embodiment as a facsimile device, enabling image data to be transmitted to and received from the external devices.

The apparatus control portion 3 controls the units making up the digital multi-function peripheral 1, monitors operation instructions from the input portion 4a such as a tablet or keys provided in the operation portion 4, and provides appropriate guidance and display of information such as information on the status of the digital multi-function peripheral 1 to be given to the user via the display portion 4b. The management portion 8 manages information on the constituent units controlled by the apparatus control portion 3 and, based on such information, the apparatus control portion 3 controls the operations of the entire digital multi-function peripheral 1.

The digital multi-function peripheral 1 of the present invention aims chiefly to make its processing mode switchable depending on the time (time zone), thereby, when during the time zone where one processing mode is being executed data to be processed in the other processing mode is entered, enabling the entered data to be processed after the arrival at the hour to execute the other processing mode. To this end, the digital multi-function peripheral 1 is provided with the timer 17 that measures the time, the apparatus control portion 3 that provides a control to switch to one of at least two different processing modes depending on the time, and the HD 7 that is a storage portion for storing data. The digital multi-function peripheral 1 has a so-called print-hold function.

For example, when one processing mode is a processing mode for printing services (hereinafter, referred to as a printing service mode) and the other processing mode is a processing mode for business use (hereinafter, referred to as a business-use mode), data to be processed in the other processing mode is data to be processed in the business-use. mode, i.e., data created by a predetermined business-use terminal used for business. The digital multi-function peripheral 1 holds in advance inherent information of a business-use terminal such as an IP address so that it can recognize data entered from the business-use terminal via the network. It is to be noted that the printing service mode means a mode for providing printing service to charge therefor, including provision of copying service.

Data other than the data created by the business-use terminal is data to be processed in the printing service mode, including data entered as a result of reading a document by the image reading portion 2, data entered from an external recording medium such as a memory card, and data entered via other service-use terminal, and covers the whole of documents and external recording media (including the memory card or a digital camera) carried by the common users into shops.

When data to be processed in the business-use mode is entered during the time zone where the printing service mode is being executed, the apparatus control portion 3 provides a control to temporarily hold the entered data on the HD 7 till the hour to execute the business-use mode and read the data held on the HD 7 once the hour to execute the business-use mode arrives, to perform print processing, etc. It is to be noted that functions corresponding to the forms of use of the digital multi-function peripheral 1 are assigned to the above modes.

The number of switchable modes is not limited to two but three or more switchable modes may be set depending on the number of modes. As used herein, the term “function” refers to e.g., one or more functions of copier function, printer function, scanner function and facsimile function, and may cover, e.g., individual functions (double-sided copying function, finishing function, etc.) included in the copier function.

The management portion 8 has accumulatively a printing service program for displaying an operation screen to which the printing service function is assigned, and a business-use program for displaying an operation screen to which the business-use function is assigned. Depending on the time provided by the timer 17, the apparatus control portion 3 reads for execution either the printing service program or the business-use program from the management portion 8.

For example, in case of disposing and using the digital multi-function peripheral 1 in a shop, etc., control is provided such that it functions as a self copier for common users executing the printing service program during the time zone of daytime (e.g., 09:00 to 18:00 hours) and that it functions as a business-use copier executing the business-use program during the time zone of nighttime (e.g., 18:00 to 09:00 hours on the next day) after closure of the shop, thereby switching the operation screens depending on the time zone. When e.g., 09:00 hours arrive during displaying the business-use operation screen as a result of execution of the business-use program, the apparatus control portion 3 automatically executes the printing service program to switch the screen of the display portion 4b to the printing service operation screen. It is to be noted that, when the power of the digital multi-function peripheral 1 is turned on from off state, the timer 17 measures the time at that time, based on which result the apparatus control portion 3 reads a either program for execution.

FIG. 2 depicts a configuration example of a system including the digital multi-function peripheral 1 and the accounting device that are connected to each other. The digital multi-function peripheral 1 is connected to the accounting device 50 for charging for copy processing effected by the digital multi-function peripheral 1. The accounting device 50 includes a display portion 51 for displaying accounting information, an operation panel 52 for entering a user operation, a slot portion 53 for receiving a coin or a prepaid card, a ROM 54 storing a control program, etc., a CPU 55 controlling the entire accounting device 50, a memory 56 that is an area to execute the control program, and an I/F 57 for connection to the digital multi-function peripheral 1.

The I/F 16 of the digital multi-function peripheral 1 is connected to the I/F 57 of the accounting device 50 so that the apparatus control portion 3 of the digital multi-function peripheral 1 provides a control of accounting processing effected by the accounting device 50. Assume herein that the accounting processing portion 14 sets 10 yen per A4 black-and-white copy. The user inserts 200 yen in advance through the slot portion 53 of the accounting device 50. In accordance with the user operation, the digital multi-function peripheral 1 executes copying from a document to recording paper to create ten A4 black-and-white copies. The copy charge at that time is calculated at the number 10 of copies×10 yen/copy=100 yen by the accounting processing portion 14, with the result that the apparatus control portion 3 instructs the accounting device 50 to subtract the 100 yen. In compliance with the instruction from the apparatus control portion 3, the accounting device 50 performs processing to subtract “100 yen” from “200 yen” that is the inserted amount of money to return the remainder.

The accounting processing portion 14 may set the copy charge depending on e.g., the number of copies, the type of copy (such as color or black-and-white), and the paper size (such as A4 or B4). Thus, the digital multi-function peripheral 1 of the present invention is capable of providing charged copying service for common users.

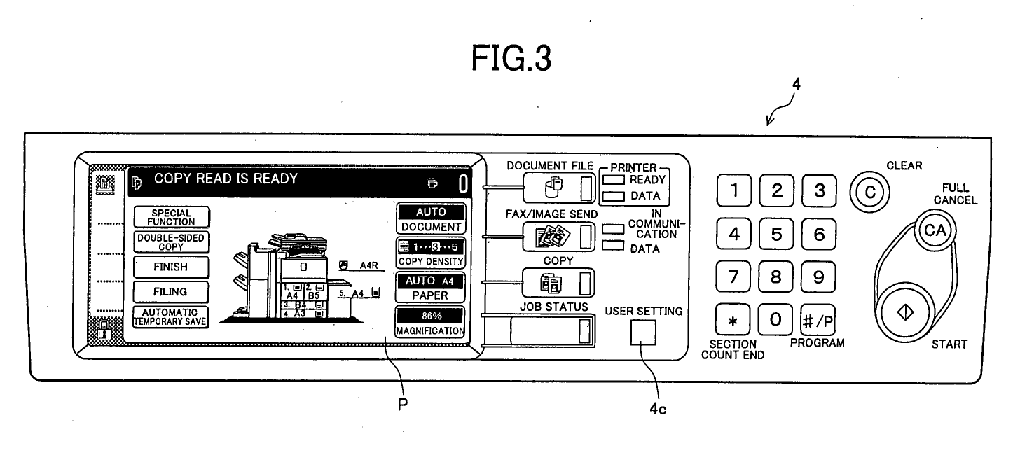

With reference to FIGS. 3 to 9, description will hereinafter be made of processing to set the time zones and the operation screens (processing modes) in an associated manner. This processing is carried out by the apparatus control portion 3 and the operation portion (the input portion 4a and the display portion 4b).

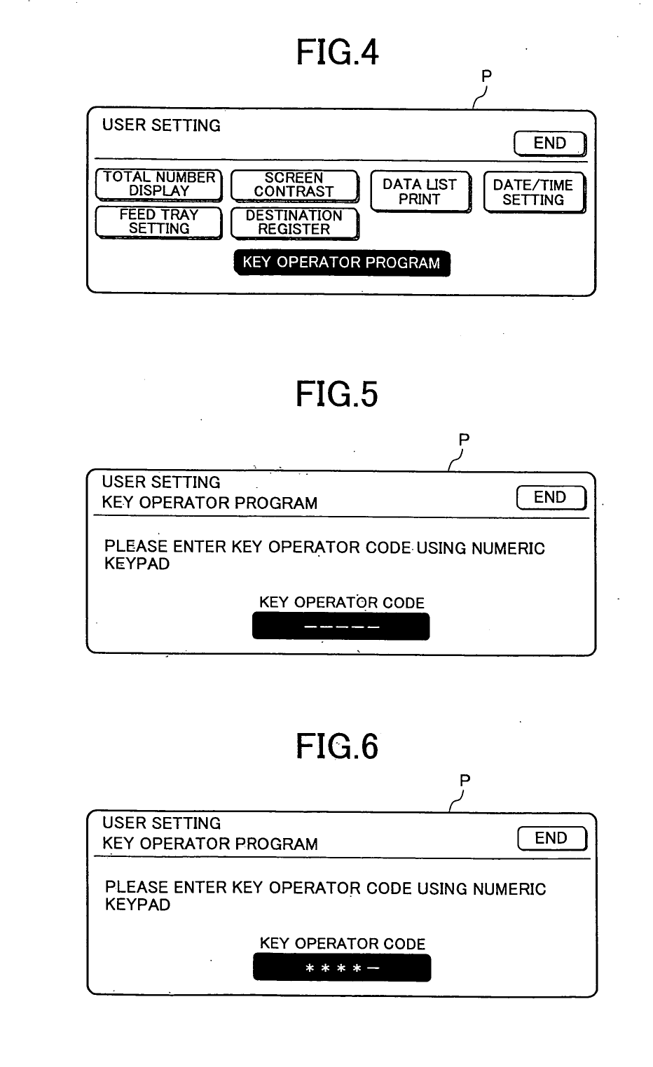

FIG. 3 depicts a configuration example of the operation portion 4 of the digital multi-function peripheral 1. Referring to FIG. 3, the operation portion 4 includes a touch panel P and a user setting button 4c. The touch panel P of FIG. 3 provides a display of the business-use operation screen. Various functions are assigned to the business-use operation screen that include “special function”, “double-sided copy”, “finish”, “filing”, and “automatic temporary retention”. The operator such as a system manager presses the user setting button 4c to set the business-use operation screen and the printing service operation screen in a manner associated with corresponding time zones to be displayed. Afterward, the setting screen transitions as shown in FIGS. 4 to 9.

FIG. 4 depicts an example of a user setting screen displayed on the touch panel P of the digital multi-function peripheral 1. The user setting screen includes, e.g., items such as “total number display”, “screen contrast”, “data list print”, “date/time setting”, “feed tray setting”, “destination register”, and “key operator program”. This example shows the state where the item “key operator program” is selected.

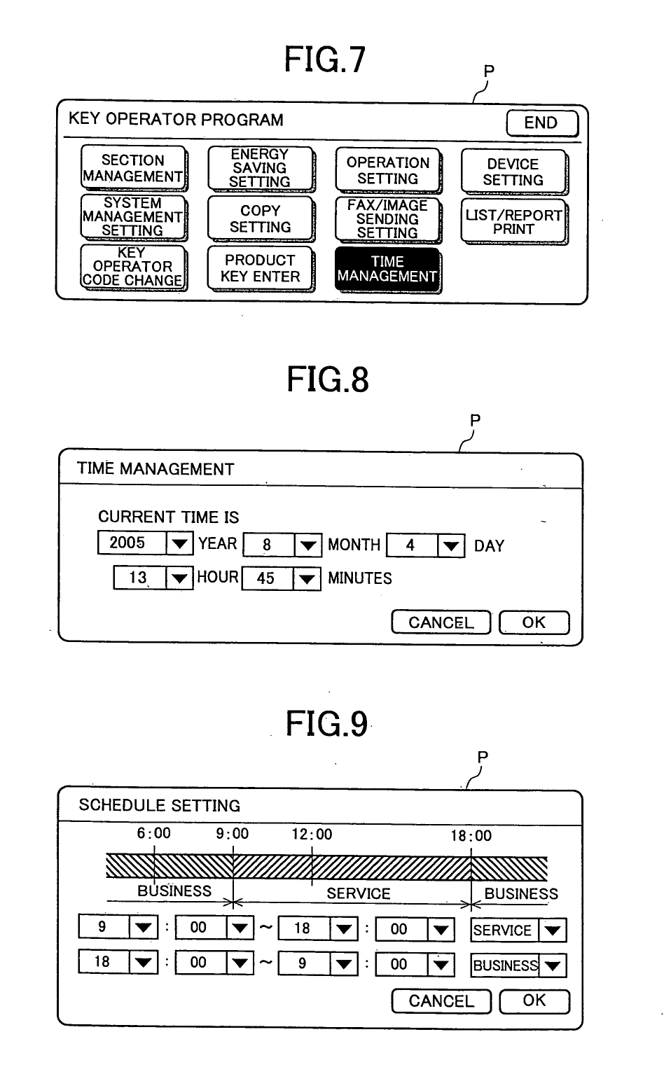

FIG. 5 depicts an example of an authentication information input screen for allowing a key operator program setting screen to appear on the touch panel P of the digital multi-function peripheral 1. FIG. 6 depicts another example of the authentication information input screen. On the authentication information input screen of FIG. 5, the operator enters a key operator code that is authentication information using e.g.., the numeric keypad of the digital multi-function peripheral 1. FIG. 6 shows the state where the key operator code is entered. When the authentication is accepted, the digital multi-function peripheral 1 displays a key operator program setting screen shown in FIG. 7 that will be described below.

FIG. 7. depicts an example of the key operator program screen appearing on the touch panel P of the digital multi-function peripheral 1. The key operator program screen includes, e.g., items such as “section management”, “energy saving setting”, “operation setting”, “device setting”, “system management setting”, “copy setting”, “fax/image sending setting”, “list/report print”, “key operator code change”, “product key enter”, and “time management”. This example shows the state where the item “time management” is selected. In this manner, the operator authenticated on the authentication information input screen of FIGS. 5 and 6 is allowed to perform various settings for the key operator program shown in FIG. 7.

FIG. 8 depicts an example of a time management screen appearing on the touch panel P of the digital multi-function peripheral 1. The time management screen is a screen for setting the date and time. If the date and time are correct, an “OK” button is pressed to shift to a schedule setting screen shown in FIG. 9. If the date and time are incorrect, “V” is pressed to adjust to the correct date and time, after which the “OK” button is pressed to shift to the schedule setting screen.

FIG. 9 depicts an example of the schedule setting screen appearing on the touch panel P of the digital multi-function peripheral 1. The schedule setting screen is a screen for setting two different operation screens (for printing services and for business use in this example) in a manner associated with the time zones to display the corresponding operation screens. Setting of this example is such that the operation screen for printing services is displayed during the time zone of 09:00 to 18:00 hours and that the operation screen for business use is displayed during the time zone of 18:00 to 09:00 hours on the next day. If those details of setting are acceptable, the “OK” button is pressed to end the setting processing. As a result, in accordance with the above setting, the apparatus control portion 3 executes the printing service program once 09:00 hours arrive, to display the operation screen for printing services, and further executes the business-use program once 18:00 hours arrive, to perform processing to switch to the operation screen for business use.

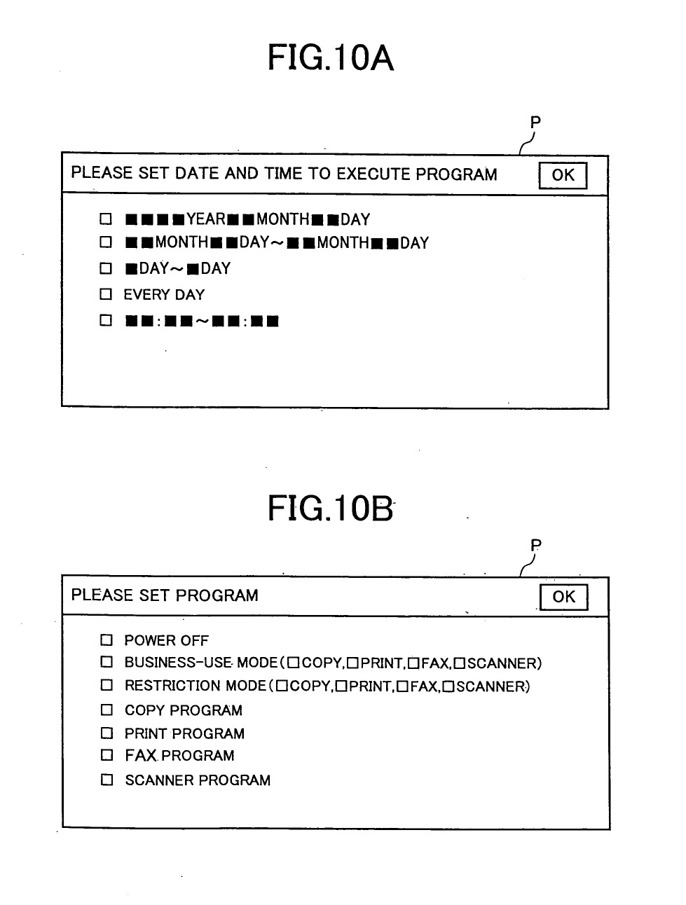

FIG. 10A depicts an example of a time setting screen appearing on the touch panel P of the digital multi-function peripheral 1 and FIG. 10B depicts an example of a program setting screen appearing on the touch panel P of the digital multi-function peripheral 1. The time setting screen of FIG. 10A is a screen for setting the date and time to execute the programs (such as the printing service program and the business-use program), enabling an execution date (e.g., 2005/10/01), an execution period (e.g., 10/01 to 10/10), execution days (e.g., Mon. to Fri.) or every day, an execution time zone (e.g., 09:00 to 18:00 hours), etc., to be set by checking check boxes (□).

The program setting screen of FIG. 10B is a screen for setting a program to be executed based on the details set in FIG. 10A. Checking check boxes (□) enables settings of e.g., a power off for turning off the power of the digital multi-function peripheral 1, a business-use mode for using the digital multi-function peripheral 1 as business use (further enabling setting of copy, print, FAX, and scanner), a restriction mode for imposing various restrictions on the functions for use (further enabling setting of copy, print, FAX, and scanner), a copy program for using the copier function, a print program for using the print function, a FAX program for using the FAX function, and a scanner program for using the scanner function.

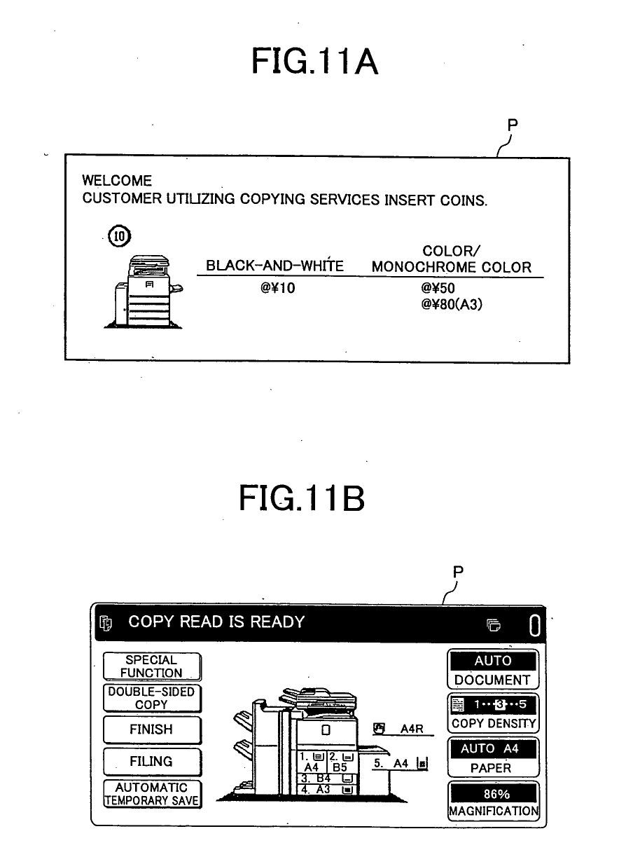

FIGS. 11A and 11B depict examples of the operation screen appearing on the touch panel P of the digital multi-function peripheral 1. The operation screen of FIG. 11A is an operation screen for printing services appearing during the time zone of daytime (e.g., 09:00 to 18:00 hours), providing a display of copy charge information, etc. The operation screen of FIG. 11B is an operation screen for business use appearing during the time zone of nighttime (e.g., 18:00 to 22:00 hours), providing a display of the same screen as the operation screen of FIG. 3 described above. In accordance with the details of the above settings, the apparatus control portion 3 executes the printing service program once 09:00 hours arrive to allow the printing service operation screen of FIG. 11A to appear, and further executes the business use program once 18:00 hours arrive to perform processing to switch to the business-use operation screen of FIG. 11B.

The digital multi-function peripheral 1 is configured to be able to switch the processing modes (for printing services and for business use) depending on the time (time zone) and to temporarily hold, when during the time zone where one printing service mode is being executed data to be processed in the other business-use mode is entered, the entered data on the HD 7 to perform the print processing after the arrival at the hour to execute the business-use mode.

More specifically, the digital multi-function peripheral 1 reads the data held on the HD 7 for printing out the instant the hour to execute the business-use mode arrives. When the hour to execute the business-use mode arrives, the digital multi-function peripheral 1 may display on the display portion 4b a list of data held on the HD 7 and read from the HD 7 data selected from the list on the display portion 4b by the user for print processing. User authentication information (such as an ID number or a password) may be entered before the execution of the print processing so that the print processing is permitted to execute only when the user is authenticated to thereby achieve an improved degree of secrecy.

For example, in case the printing service mode applies during 09:00 to 18:00 hours and the business-use mode applies from 18:00 hours onward, if business-mode data is entered at 15:00 hours, three hours or more intervene before the execution of the print processing since the print processing is executed from 18:00 hours onward. For this reason, some users may inadvertently forget that the data is held. Thus, in any case of the above print processing, the user may be notified that data is held on the HD 7 the instant the hour to execute the business-use mode arrives.

Such notifying means can assume various forms such as a manner of displaying a message on the display portion 4b of the digital multi-function peripheral 1, an optical manner of causing a predetermined portion of the digital multi-function peripheral 1 to flash, an acoustic manner of issuing an alarm sound or a synthetic voice, and a manner of sending electronic mail to a user mobile terminal. This enables the user to be notified that print processing starts just now, thereby preventing the user from e.g., forgetting to take out print-processed matters.

The digital multi-function peripheral 1 is provided with the image reading portion 2 for entering data through reading documents, and the communication portion 5 for entering data from business-use terminals via the network 30. Data entered from the communication portion 5 is data from the business-use terminals, and hence, when the data is entered during the time zone of the printing service mode, the data is temporarily held on the HD 7 without being print-processed. However, some of data from the business-use terminals may be to urgently be printed out.

In order to deal with such a case, the apparatus control portion 3 may be able to determine, based on the user's option, whether entered data processing to be performed from the hour to execute the business-use mode onward when the data is entered from the communication portion 5 during the time zone where the printing service mode is being executed.

To this end, the digital multi-function peripheral 1 displays a screen for user's option on the display portion 4b so that, when the user selects the print processing, the data is print-processed at once without being held on the HD 7. When the user selects hold on the HD 7, the data is held on the HD 7 without being processed and is processed after the business-use mode execution time onward.

It may also be supposed that specific data held on the HD 7 needs to be printed out during the time zone where the printing service mode is being executed. In order to deal with such a case, a list of data held on the HD 7 may be displayed on the display portion 4b irrespective of the time zone where the printing service mode is being executed so that data selected from the list by the user can be read from the HD 7 and processed.

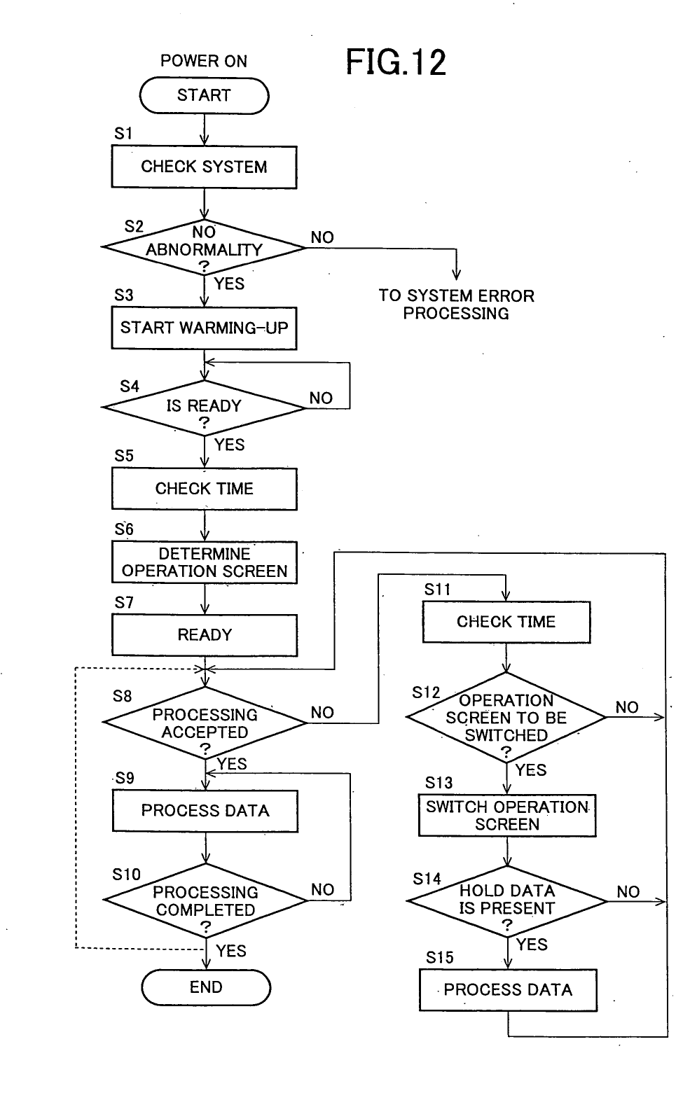

FIG. 12 is a flow diagram for explaining the flow of operation screen switching display processing effected by the digital multi-function peripheral 1 of the present invention. First, the digital multi-function peripheral 1 performs a system check (step S1) to determine whether the system has no abnormality (step S2), and if abnormality is present (case of NO), shifts to a system error process. If abnormality is absent at step S2 (case of YES), the digital multi-function peripheral 1 starts warming-up (step S3) to determine whether it is ready (step S4), and if affirmative, that is, it is ready (case of YES), checks the current time (step S5). If negative, that is, it is not ready (case of NO) at step S4, then the processing at step S4 is repeated.

Based on the time checked at step S5, the digital multi-function peripheral 1 determines an operation screen (for printing services in this example) to be displayed (step S6), shifting to the ready mode for entry of data processing such as copying (step S7). The digital multi-function peripheral 1 determines whether it has accepted the data processing (step S8), and if affirmative (case of YES), executes the data processing (step S9) to determine whether it has completed the data processing (step S10), and if negative (case of NO), returns to step S9 for repetition of the processing. If affirmative (case of YES) at step S10, then control intactly comes to an end or returns to step S8, shifting to standby mode for acceptance of data processing.

If the digital multi-function peripheral 1 does not accept the data processing at step S8 (case of NO), then it performs a time check (step S11), and based on the result, determines whether the operation screen is to be switched (step S12). If affirmative, that is, it is determined that the operation screen is to be switched (case of YES), the digital multi-function peripheral 1 switches the operation screen (step S13) to determine whether hold data is present (step S14). If affirmative, that is, the hold data is present (case of YES), then it processes the data (step S15) and returns to step S8, shifting to the standby mode for acceptance of data processing.

If it is determined that the operation screen is not to be switched at step S12 (case of NO) or if it is determined that no hold data is present at step S14 (case of NO), control returns to step S8, shifting to the standby mode for acceptance of the data processing.

Since the timer 17 of the digital multi-function peripheral 1 is operating at all times at step S11, the apparatus control portion 3 may see the timer 17 at all times or every given time to check the time. Alternatively, the timer 17 may inform the apparatus control portion 3 of arrival at the switching hour.

When the hour to switch the operation screen arrives in the course of data processing, the operation screen is to be switched after the completion of a series of data processing so that the data processing is not interrupted halfway. Although the operation screen switching processing is automatically carried out depending on the time (time zone), manual switching may be done by the system manager, etc. if necessary.

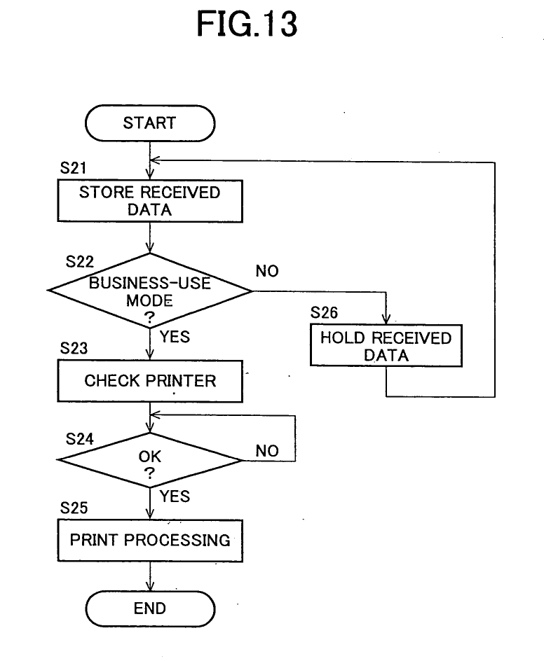

FIG. 13 is a flow diagram for explaining the flow of processing on data reception effected by the digital multi-function peripheral 1 of the present invention. Description will be made of an example when the digital multi-function peripheral 1 receives data from a business-use terminal. First, the digital multi-function peripheral 1 temporarily stores data received from the business-use terminal on the HD 7 (step S21), determines from the current hour whether the mode in execution is the business-use mode (step S22), and if affirmative, that is, the business-use mode is in execution (case of YES), checks the state of the printer (step S23).

The digital multi-function peripheral 1 determines whether printing out is possible (step S24), and if affirmative (case of YES), prints out the received data (step S25). If negative, that is, printing out is not possible at step S24 (case of NO), the digital multi-function peripheral 1 stands by at step S24 till the printing out becomes possible.

On the other hand, if the mode in execution is not the business-use mode but the printing service mode at step S22 (case of NO), the received data is held intactly on the HD 7 (step S26) returning to step S21.

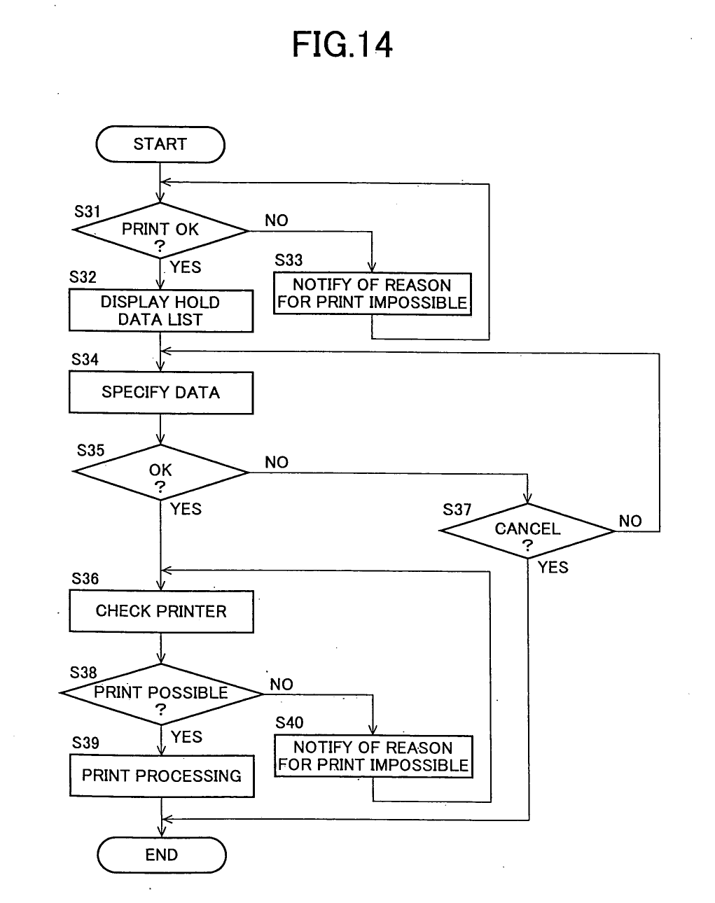

FIG. 14 is a flow diagram for explaining the flow of processing when printing out hold data during the printing service effected by the digital multi-function peripheral of the present invention. Description will be made of an example of printing out, during the time zone where the printing service mode is being executed, data received from the business-use terminal and held on the HD 7. First, the digital multi-function peripheral 1 determines whether printing out is possible (step S31), and if affirmative (case of YES), displays a list of data being held on the HD 7 on the display portion 4b (step S32).

If negative, that is, printing out is not possible at step S31 (case of NO), the digital multi-function peripheral 1 notifies the user of the reason printing is impossible (step S33), returning to step S31 for repetition of the processing. The digital multi-function peripheral 1 then specifies data based on the user's option from among hold data displayed in the list (step S34) to perform processing such as checking the paper size of the specified data (step S35), and iff OK (case of YES), checks the state of the printer (step S36). If not OK at step S35 (case of NO), the digital multi-function peripheral 1 determines whether to cancel the specified data (step S37), and if affirmative (case of YES), comes to an end. If negative at step S37 (case of NO), control returns to step S34 for repetition of the processing.

The digital multi-function peripheral 1 determines whether printing is possible (step S38), and if affirmative (case of YES), performs print processing of the data specified at step S34 (step S39). If negative, that is, printing is not possible (case of NO) at step S38, the digital multi-function peripheral 1 notifies the user of the reason printing is impossible (step S40), returning to step S36 for repetition of the processing.

As set forth hereinabove, according to the present invention, the data processing apparatus having at least two different processing modes is capable of switching the processing modes depending on the time (time zone) so that when during the time zone where one processing mode is being executed data to be processed in the other processing mode is entered, the entered data is processed after the hour to execute the other processing mode, thereby enabling data created by business-use PCs (personal computers) etc., to be held in the data processing apparatus even during the time zone where the printing service mode is being executed, to print out the entire hold data collectively or desired data selectively the instant the hour to execute the business-use mode arrives.

1. A data processing apparatus having at least two different processing modes, comprising:
a timer that measures a time; and
a control portion that controls switching to one of the at least two different processing modes depending on the time, the control portion providing a control such that when during a time zone where one of the processing modes is being executed data to be processed in the other processing mode is entered, the entered data is processed after a time to execute the other processing mode.

2. The data processing apparatus as defined in claim 1, further comprising a storage portion that holds the entered data, wherein the data held on the storage portion is read and processed the instant the time to execute the other processing mode arrives.

3. The data processing apparatus as defined in claim 1, further comprising a storage portion that holds the entered data, wherein a list of the data held on the storage portion is allowed to be displayed the instant the time to execute the other processing mode arrives so that data selected by a user from the list is read from the storage portion for processing.

4. The data processing apparatus as defined in claim 2 or 3, wherein the apparatus notifies that data is held on the storage portion the instant the time to execute the other processing mode arrives.

5. The data processing apparatus as defined in claim 1, further comprising a first input portion that reads a document to enter data, and a second input portion that enters data from an external device via a network, wherein the control portion determines based on a user's option whether when during the time zone where the one processing mode is being executed data is entered from the second input portion, the entered data is to be processed after the time to execute the other processing mode.

6. The data processing apparatus as defined in claim 5, further comprising a storage portion that holds the entered data, wherein a list of the data held on the storage portion is allowed to be displayed during the time zone where the one processing mode is being executed so that data selected by the user from the list is read from the storage portion for processing.

7. The data processing apparatus as defined in claim 1, wherein the one processing mode is a printing service mode for providing printing services to charge for the services, wherein the other processing mode is a business-use mode for use in general business, and wherein data to be processed in the other processing mode is data entered from a predetermined business-use terminal used in the business-use mode via a network.
